(19) United States
(12) Patent Application Publication
(10) Pub. No.: US 2014/0331638 A1
(43) Pub. Date: Nov. 13, 2014

(54) METHOD FOR PRODUCING A CATALYST FLOW ELEMENT AND CATALYST FLOW ELEMENT

(71) Applicant: Hug Engineering AG, Elsau (CH)

(72) Inventors: Christoph Hug, Wiesendangen (CH); Hans Thomas Hug, Weisslingen (CH)

(73) Assignee: Hug Engineering AG

(21) Appl. No.: 14/340,268

(22) Filed: Jul. 24, 2014

Related U.S. Application Data
(63) Continuation of application No. PCT/EP2013/051402, filed on Jan. 25, 2013.

(30) Foreign Application Priority Data
Jan. 27, 2012 (DE) 102012100687.3
Sep. 17, 2012 (DE) 102012108698.2

(51) Int. Cl. B01D 53/94; F01D 25/30

(52) U.S. Cl. CPC B01D 53/94; F01D 25/30; B01D 2255/90
USPC 60/39.5; 137/15.01; 137/599.01; 29/428; 422/180; 423/212

(57) ABSTRACT

To provide a method for producing a catalyst flow element (100) by means of which robustly constructed catalyst flow elements (100) usable in a broad field of operation are producible, it is proposed that the following method steps be performed in the method: providing a main body (102) including a plurality of flow channels (104); introducing slots (116) into partition walls (110) of the main body (102), which separate the flow channels (104) from one another such that at least two adjacent flow channels (104) are connected together fluidically within the main body (102) in a common end region (130) of the at least two adjacent flow channels (104); and arranging channel closures (118) in the common end region (130) for fluid-tight closure of the common end region (130) while maintaining the fluidic connection between the at least two adjacent flow channels (104) in the common end region (130).

### CROSS-REFERENCE TO RELATED APPLICATIONS

This application is a continuation of international application No. PCT/EP2013/051402, filed on Jan. 25, 2013, and claims the benefit of German Application Nos. 10 2012 100 687.3, filed on Jan. 27, 2012 and 10 2012 108 698.2, filed on Sep. 17, 2012, which are incorporated herein by reference in their entirety and for all purposes.

### FIELD OF DISCLOSURE

The present invention relates to a method for producing a catalyst flow element.

### BACKGROUND

A catalyst flow element may be used, for example, to convert pollutants into substances less harmful to health and/or the environment. In particular, such a catalyst flow element may be used in an exhaust gas line of a thermal engine. In this case, the catalyst flow element may be exposed to high thermal and/or mechanical loads, which may impair its reliability and durability.

### SUMMARY OF THE INVENTION

It is an object of the present invention to provide a method for producing a catalyst flow element which can be used to produce catalyst flow elements of robust construction and usable in a broad field of operation.

This object is achieved according to the invention in that, in a method for producing a catalyst flow element, the following method steps are performed:

providing a main body comprising a plurality of flow channels;

introducing slots into partition walls of the main body, which separate the flow channels from one another such that at least two adjacent flow channels are connected together fluidically within the main body in a common end region of the at least two adjacent flow channels;

arranging channel closures in the common end region for fluid-tight closure of the common end region while maintaining the fluidic connection between the at least two adjacent flow channels in the common end region.

Because the method for producing a catalyst flow element involves providing slots and channel closures by means of which adjacent flow channels may be fluidically connected together and preferably sealed against the environment surrounding the catalyst flow element, it is possible to produce a catalyst flow element with advantageous flow guidance, in particular an advantageous through-flow path, which enables use in a broad field of operation and is of robust construction.

Flow channels are in particular linear cavities in the main body extending substantially parallel to one another and/or open on both sides at least prior to the introduction of channel closures.

Preferably at least approximately all the flow channels are of substantially identical construction. Provision may in particular be made for substantially all the flow channels to have at least approximately identical dimensions.

Slots in the partition walls of the main body may for example take the form of indentations.

It may be advantageous for the main body to be produced using an extrusion method.

In particular, provision may be made for the main body to be made from a malleable ceramic material.

A cordierite material, which comprises cordierite, may for example be provided as the starting material for the main body.

The partition walls are preferably substantially impermeable to gas.

It may be favorable for the main body to be given its basic shape and/or a specified length using an extrusion method.

Provision may be made for the main body to be dried using a freeze-drying method.

Provision may further be made for the main body to be cut to length.

Provision may further be made for the main body to undergo further processing.

After the extrusion process, the main body is preferably cut off, freeze-dried, cut to length and then further processed.

Further processing is understood in particular to mean the introduction of slots.

It may be favorable for the positions of the partition walls to be determined prior to introduction of the slots using an image recording device and an image analysis device.

In particular, it is possible in this way to determine the partition walls into which slots are introduced, in order to connect adjacent flow channels fluidically together.

Preferably only single slots are introduced into the partition walls, in particular in such a way that preferably only ever two flow channels are connected together fluidically on one side of the main body.

It may be favorable for the slots and/or the channel closures respectively to be introduced into the main body or arranged on the main body in a regular pattern. This enables uniform through-flow of the catalyst flow element by a gas stream.

Provision may in particular be made for the slots and/or the channel closures respectively to be introduced into the main body or arranged on the main body in accordance with a predetermined plan, for example at least in places in a chequered pattern.

In one configuration of the invention provision is made for the slots and/or the channel closures respectively to be introduced into the main body or arranged on the main body in such a way that horizontally adjacent flow channels and vertically adjacent flow channels are flowed through in mutually opposed through-flow directions when the catalyst flow element is in operation. In this way, heat exchange within the catalyst flow element may be optimized.

In this description and the appended claims, operation of the catalyst flow element should be understood in particular to mean through-flow of the catalyst flow element by a pollutant-containing gas stream, in particular by exhaust gas from a combustion device.

Arranging the slots and channel closures such that horizontally adjacent flow channels and vertically adjacent flow channels are flowed through in mutually opposed flow directions when the catalyst flow element is in operation in particular enables heat transfer in the horizontal and vertical directions.

In this description and the appended claims, horizontally adjacent flow channels should be understood to mean flow channels which are arranged adjacent one another in a horizontal direction and perpendicular to the through-flow direction when through-flow through the main body is horizontal.

In this description and the appended claims, vertically adjacent flow channels should be understood to mean flow channels which are arranged adjacent one another in a vertical direction and perpendicular to the through-flow direction when through-flow through the main body is horizontal.

The slots are introduced into the partition walls of the main body for example by means of a milling device, in particular a computer-controlled milling device.

In particular, provision may be made for the slots to be introduced into the main body before a main body firing process is performed.

A milling head of the milling device preferably has a diameter which corresponds substantially to the width, in particular the diameter, of the flow channels.

A position of the partition walls to be provided with slots is preferably established using the image recording device and the image analysis device. Using the milling device, the slots may then be introduced into the partition walls in particular automatically and with a high degree of accuracy.

The slots preferably have a depth which makes it possible for a fluid connection to be obtained between adjacent flow channels even after arrangement of the channel closures. In particular, provision may be made for the slots to have a depth which corresponds to the sum of the thickness of the channel closure and the width of the flow channel, in particular the diameter of the flow channel.

By using an image recording device and an image analysis device, in particular an image processing device, the main body may be machined in a particularly precise manner, in particular so as to be able to take account of manufacturing differences between individual main bodies.

It may be advantageous for the slots to be introduced into the main body distributed in such a manner that, on one side of the main body, two flow channels each, in particular always only two flow channels each, are connected fluidically to each other by means of, in each case, one slot.

In a further configuration of the invention, provision may be made for the slots to be introduced into the main body distributed in such a way that on one side of the main body in each case one pair of flow channels connected together fluidically by means of one slot is surrounded by four flow channels which directly adjoin the pair of flow channels and are not connected fluidically with further flow channels on this side of the main body.

It may be advantageous for the main body to be provided on both sides with slots and channel closures.

In particular, provision may be made for the main body to be provided with slots and channel closures on mutually opposite sides, in particular on an inlet side and an outlet side. In this way, the gas streams flowing into the main body can be simply separated spatially from the gas streams flowing out of the main body.

It may be favorable for in each case three flow channels to be connected fluidically together by means of in each case two slots, which are arranged at mutually opposite end regions of the flow channels.

In this way, a “three-way assembly” may be produced.

A through-flow path through the main body is then preferably formed of three flow channels, wherein on a first side of the main body, namely the inlet side of the main body, a first flow channel is configured to be open, while a second and a third flow channel are covered using channel closures. On the second side opposite the first side, namely on the outlet side of the main body, the third channel is then preferably configured to be open, while the first flow channel and second flow channel are closed by means of channel closures.

The first flow channel and second flow channel are then preferably connected fluidically together by means of a slot in the region of the outlet side, such that a first flow deflection is formed.

The second flow channel and third flow channel are moreover preferably connected fluidically together by means of a slot in the region of the inlet side, such that a second flow deflection is formed.

A gas stream flowing into the main body through an inlet orifice then preferably flows along the first flow channel from the inlet side to the outlet side, is guided via the flow deflection on the outlet side and along the second flow channel back to the inlet side, there deflected again by means of the further flow deflection and finally via the third flow channel to the outlet side, where it passes out of the main body through an outlet orifice.

The main body and/or the catalyst flow element may in principle have any desired shape, in particular any desired honeycomb shapes. The main body and/or the catalyst flow element and/or honeycomb cells of the main body or of the catalyst flow element may for example be cylindrical with a rectangular, in particular square, round, oval etc. cross-section.

Depending on production or machining of the catalyst flow element and/or of the main body, the shape may deviate from the ideal shape and/or from a geometric pattern, in particular the honeycomb shape, in particular in marginal regions.

The main body is preferably a honeycomb structure of substantially square cross-section and with honeycomb cells arranged in a square pattern in the manner of a matrix and having a substantially square cross-section.

The main body thus preferably comprises rows and columns of flow channels.

It may be advantageous for the slots to be introduced into the main body and the channel closures to be arranged on the main body in such a way that the flow channels of every third column or every third row of flow channels are provided on both sides with channel closures.

Preferably, the flow channels provided on both sides with channel closures are those flow channels which are connected fluidically on both sides with further flow channels.

It may be advantageous for the main body to be fired. This imparts elevated strength to the main body.

In particular, provision may be made for the main body to be fired after introduction of the slots.

Provision may for example be made for the main body to be fired in a sintering step.

The main body may for example be heated to at least around 1000° C., for example to at least around 1200° C., in particular to around 1300° C.

It may be favorable for the main body to be provided with a catalytic coating. In this way chemical reactions which occur in the main body on through-flow of the catalyst flow element may be specifically influenced, in particular accelerated.

The main body is preferably coated on the inside, such that the partition walls of the main body are coated with the catalytic coating.

Provision may be made for the main body to be provided with a catalytic coating by dipping into a liquid composition containing noble metal.

The main body is preferably provided with a catalytic coating after introduction of the slots and/or after performance of a firing process and/or prior to arrangement of the channel closures.

It may be advantageous for the main body to be dried and/or calcined after performance of the coating process. The main body may to this end in particular be heated, for example to a temperature of around 400° C.

In one configuration of the invention, the main body is provided with a mask for the purpose of arranging the channel closures.

A mask may for example comprise a film which preferably initially completely covers an inlet side or an outlet side of the main body.

An image recording device and/or an image analysis device is/are preferably used to identify the points at which the mask must be provided with orifices in order to be able to arrange the channel closures at the correct positions on the main body.

Using a machining device, for example a laser device, the mask may then be provided with openings, in particular at those points which have been identified as the correct positions by means of the image recording device and/or the image analysis device.

The openings in the mask are preferably produced at those flow channels in which slots are provided in the partition walls.

The openings are preferably dimensioned such that the open ends of flow channels connected with further flow channels by means of slots and the slots themselves are exposed.

It may be favorable for the flow channels to be filled in part by means of a malleable material on arrangement of the channel closures.

In particular, the flow channels may be provided with channel closures by partially filling said flow channels with a malleable material.

The flow channels are preferably filled to an extent such that, starting from an outer surface of the main body, the thickness of the channel closures corresponds substantially to the diameter of the flow channels.

The malleable material is preferably delivered, in particular pressed, through the mask, in particular through the openings in the mask.

The channel closures are thus in particular stoppers which seal the previously open ends of the flow channels.

The material of the channel closures may preferably be converted.

For example, provision may be made for the main body to be heated together with the malleable material introduced into the flow channels in order to solidify the channel closures.

It is favorable for the channel closures to be joined to the main body by heating.

For example, provision may be made for the channel closures to be connected by a substance-to-substance bond to the main body by heating with the main body.

The main body and the channel closures are to this end preferably heated to above a quartz transition temperature of the material of the main body, for example to at least around 450° C., in particular to around 500° C.

The main body with the channel closures is preferably heated to at most around 700° C., in particular to at most around 600° C., so as not to damage any optionally present catalytic coating.

Provision may be made for a plurality of main bodies to be joined together, in particular adhesively bonded, to enable production of an assembly of a plurality of main bodies of any desired size.

To bring the assembly of a plurality of main bodies into a predetermined shape, this assembly may for example be sawn into shape.

The present invention also relates to a catalyst flow element.

The object of the invention in this respect is to provide a catalyst flow element, which is of robust construction and is usable in a broad field of operation.

This object is achieved according to the invention in that the catalyst flow element comprises a main body comprising the following:

an inlet side, on which a fluid stream may flow into the main body;

an outlet side opposite the inlet side, on which the fluid stream may exit from the main body; and

a plurality of meandering through-flow paths connecting the inlet side with the outlet side.

The present object is further achieved by a catalyst flow element, in particular a catalyst flow element as described above, which comprises a main body comprising the following:

a plurality of flow channels;

slots in partition walls of the main body, which separate the flow channels from one another such that at least two adjacent flow channels are connected together fluidically within the main body in a common end region of the at least two adjacent flow channels; and

channel closures in the common end region for fluid-tight closure of the common end region while maintaining the fluidic connection between the at least two adjacent flow channels in the common end region.

Such catalyst flow elements may be of particularly robust construction and usable in a broad field of operation.

A catalyst flow element according to the invention may possess individual ones or a plurality of the features and/or advantages described above in connection with the method according to the invention for producing a catalyst flow element.

A through-flow path of the catalyst flow element preferably comprises at least two flow deflections.

It may be favorable for the through-flow paths of the catalyst flow element to have precisely two flow deflections per through-flow path.

It may be favorable for the slots and/or the channel closures to be arranged on the main body in accordance with a regular pattern, in particular in accordance with a predetermined plan, in particular at least in places in a chequered pattern.

It may be advantageous for the slots and/or channel closures to be arranged in such a way on the main body that horizontally adjacent flow channels and vertically adjacent flow channels are flowed through in mutually opposed through-flow directions when the catalyst flow element is in operation.

The diameter of the fluid connection between two flow channels connected together by slots preferably substantially corresponds to the width of the flow channels, in particular the diameter of the flow channels.

The slots are preferably arranged on the main body distributed in such a manner that on one side of the main body in each case two flow channels are connected fluidically together by means of in each case one slot.

In particular, provision may be made for the slots to be arranged on the main body distributed in such a manner that on one side of the main body always only two flow channels each are connected fluidically to each other by means of, in each case, one slot.

It may be favorable for the slots to be arranged on the main body distributed in such a way that on one side of the main body in each case one pair of flow channels connected together fluidically by means of one slot is surrounded by four flow channels which directly adjoin the pair of flow channels and are not connected fluidically with further flow channels on this side of the main body. This enables advantageous heat transfer within the catalyst flow element.

The main body is preferably provided on both sides, in particular on an inlet side and an outlet side, with slots and channel closures. This allows in particular meandering through-flow paths, wherein inlet orifices and outlet orifices of the catalyst flow element are arranged in mutually opposite manner, such that gas flowing into the catalyst flow element on an inlet side may be separated particularly simply from gas flowing out of the catalyst flow element on an outlet side.

Preferably, in each case three flow channels are connected fluidically together by means of in each case two slots arranged at mutually opposite end regions of the flow channels.

It may be favorable for the slots and the channel closures to be arranged on the main body in such a way that the flow channels of every third column or every third row of flow channels are provided on both sides with channel closures.

The main body preferably comprises a catalytic coating.

The method according to the invention and/or the catalyst flow element according to the invention further preferably possess individual ones or a plurality of the features and/or advantages described below in connection with further methods and/or devices.

A catalyst flow element is preferably suitable in particular for use in a purification device for purifying a crude gas stream.

The present invention therefore also relates to a purification device for purifying a crude gas stream which, due to use of a catalyst flow element according to the invention, is of robust construction and usable in a broad field of operation.

A catalyst flow element according to the invention is moreover suitable for use in a thermal engine.

The present invention therefore also relates to a thermal engine comprising a combustion device, a turbine device and an exhaust gas flow guide system together with a catalyst flow element according to the invention.

In the case of the thermal engine according to the invention, exhaust gas removed from the combustion device by means of the exhaust gas flow guide system may preferably firstly be passed through the catalyst flow element and then supplied to the turbine device.

It may be favorable for the combustion device to take the form of a combustion engine.

The turbine device preferably takes the form of a turbocharger device.

The catalyst flow element is thus preferably arranged between a combustion engine and a turbocharger device. The efficiency of the thermal engine may preferably be increased as a consequence. In addition, emissions from uncombusted hydrocarbons may preferably be reduced thereby.

The use of a catalyst flow element according to the invention between the combustion engine and the turbocharger device in particular enables the use of platinum as the catalytic coating material, since the temperatures which are needed in particular for oxidizing methane (around 500° C.) arise in the region between the combustion engine and the turbocharger device and the catalyst flow element according to the invention effectively prevents an undesired drop in the temperature to below the necessary temperature due to the internal heat transfer. This in particular makes it possible to dispense with the use of palladium coatings, which are not only highly sensitive to sulfur and costly but also have short service lives.

The catalyst flow element according to the invention is therefore suitable in particular for thermal conversion of hydrocarbons.

The present invention therefore also relates to the use of a catalyst flow element for thermal conversion of hydrocarbons, in particular for oxidizing methane. Methane oxidation is particularly relevant in large gas engines with power outputs of greater than 1 MW.

In gas spark ignition engines with power outputs of up to roughly 1 MW, stoichiometric combustion of the fuel gas may take place (λ=1). By purifying the exhaust gas using a three-way catalyst, methane slip can be virtually completely prevented.

For thermal reasons, such combustion is however disadvantageous for relatively large gas engines. Preferably, therefore, in large gas engines relatively less fuel gas is supplied than would be needed for stoichiometric combustion (λ=1). The engine is thus operated with an excess of air, in particular close to the flammability limit, which may have the consequence that regions form in the combustion chamber in which a mixture of air and fuel gas is no longer within the flammability limits and thus no combustion takes place. This may result in a high methane slip value of for example around 500 to 5000 ppm, which in turn reduces efficiency and is harmful to the environment, since methane is roughly twenty-to thirty times more active as a greenhouse gas than carbon dioxide. Methane slip should therefore be reduced to 100 ppm or less.

Since in the catalyst flow element according to the invention the heat released during operation of the catalyst flow element is re-used for operation thereof, the catalyst flow element may also be called a regenerative catalyst.

In particular when used as a pre-oxidation catalyst for thermal regeneration of a diesel exhaust particulate filter, a catalyst flow element according to the invention may offer the advantage that an ignition temperature need not be maintained as an intake temperature throughout the whole regeneration process. This reduces thermal load and increases service life. In addition, the quantity of noble metal used as catalyst material may thereby be reduced.

The purification device according to the invention and/or the thermal engine according to the invention preferably possess individual ones or a plurality of the features and/or advantages described in connection with the method according to the invention and/or the catalyst flow element according to the invention.

The catalyst flow element according to the invention is suitable in particular for use in a method to heat a purification flow element for purifying a crude gas stream.

A purification flow element is for example a particulate filter, in particular a diesel exhaust particulate filter, and serves to remove particles, in particular carbon-containing soot particles, from a crude gas stream, for example from an exhaust gas stream of an internal combustion engine. Since a purification flow element configured as a particulate filter becomes clogged with particles after a given purification time, the purification flow element must be cleaned regularly. This may be achieved for example by a so-called “burn-off”, in which the purification flow element is heated to such a degree that in particular carbon-containing substances are combusted.

In an advantageous method to heat a purification flow element for purifying a crude gas stream, the following method steps are preferably performed:

through-flow of a catalyst flow element preferably according to the invention by a gas stream, wherein chemical reactions of constituents of the gas stream during through-flow of the catalyst flow element result in heat, such that the catalyst flow element is heated along at least one through-flow path and at least one more intensely heated portion of the catalyst flow element, which is arranged downstream with regard to at least one through-flow path, and at least one less intensely heated portion of the catalyst flow element, which is arranged upstream with regard to at least one through-flow path, are formed;

using heat from at least one more intensely heated portion of the catalyst flow element to heat at least a proportion of the gas stream flowing into the catalyst flow element;

supplying the gas stream guided through the catalyst flow element and heated therein to the purification flow element for heating thereof.

A catalyst flow element, which is upstream of a purification flow element, allows catalytic combustion of constituents contained in the supplied gas stream and thus efficient heating of the purification flow element.

If a simple combination of a conventional catalyst flow element and a purification flow element arranged downstream with regard to the catalyst flow element relative to a main direction of flow is used, the chemical reactions taking place in the catalyst flow element may cease if the gas stream flowing into the catalyst flow element cools the catalyst flow element to below a given limit temperature.

Preferably, therefore, heat from a more intensely heated portion of the catalyst flow element is used to heat at least a proportion of the gas stream flowing into the catalyst flow element. A continuous and thus permanently excessive reduction in the temperature of the catalyst flow element, which would prevent further chemical reactions, is preferably stopped in this way.

Preferably, at least a proportion, in particular a proportion close to the partition wall, for example a molecular boundary layer at a partition wall, of the gas stream flowing into the catalyst flow element is heated by supplying heat from a more intensely heated portion of the catalyst flow element to a temperature which makes it possible for the constituents of the gas stream to react chemically together to generate heat.

During through-flow of the catalyst flow element, the gas stream is heated from an inlet temperature to an outlet temperature. In the process, heating takes place in part through heat transfer from the catalyst flow element to the gas stream and in part through exothermic chemical reactions of the constituents of the gas stream with one another.

Preferably, an inlet temperature of the in-flowing gas stream is lower than a temperature of the gas stream which enables a chemical reaction, for example induced catalytically by the catalyst flow element, of constituents of the gas stream (limit temperature).

Preferably the gas stream is heated to the necessary temperature above the limit temperature by heat transfer from at least one more intensely heated portion of the catalyst flow element to the gas stream.

In this description and the appended claims, an inflowing gas stream is understood to mean in particular a gas stream which, starting from an inlet orifice of the catalyst flow element, has covered at most around one third, in particular at most around one fifth, of the entire through-flow path.

In this description and the appended claims, purification of a crude gas stream is understood to mean in particular conversion, absorption and/or filtering of undesired, in particular harmful, constituents of a crude gas stream to remove them from the crude gas stream.

Preferably, at least a proportion of the gas stream flowing into the catalyst flow element is brought into direct contact with at least one more intensely heated portion of the catalyst flow element, to heat said gas stream. The heat is in this case preferably transferred by thermal conduction directly from at least one more intensely heated portion of the catalyst flow element to the inflowing gas stream.

Alternatively or in addition, provision may be made for heat to be transferred from at least one more intensely heated portion of the catalyst flow element to at least one less intensely heated portion of the catalyst flow element and from the at least one less intensely heated portion of the catalyst flow element to at least a proportion of the gas stream flowing into the catalyst flow element, to heat said gas stream. In particular, provision may in this respect be made for the heat to be transferred by thermal conduction from at least one more intensely heated portion of the catalyst flow element to at least one less intensely heated portion of the catalyst flow element and thence in turn by thermal conduction to the inflowing gas stream.

It may be advantageous for at least one portion of the catalyst flow element arranged downstream with regard to at least one through-flow path and a first through-flow direction to be flowed through in a first through-flow direction for heating thereof and in a second through-flow direction for heating of at least a proportion of the gas stream flowing into the catalyst flow element.

The first through-flow direction is here preferably contrary to the second through-flow direction.

It may be favorable for at least one portion of the catalyst flow element arranged downstream with regard to at least one through-flow path and a first through-flow direction to be flowed through in a first through-flow direction for heating thereof and, with regard to the same through-flow path, in a through-flow direction opposite the first through-flow direction for heating of at least a proportion of the gas stream flowing into the catalyst flow element.

It may be favorable for the catalyst flow element to comprise spatially separate portions through which at least a proportion of the gas stream flows simultaneously in mutually opposite through-flow directions.

In addition, provision may be made for different portions of the catalyst flow element to be flowed through in chronologically overlapping manner in mutually opposite through-flow directions by at least a proportion of the gas stream.

Provision may preferably be made for at least one more intensely heated portion of the catalyst flow element which is arranged downstream with regard to at least one through-flow path, to be arranged adjacent to at least one less intensely heated portion of the catalyst flow element, which is arranged upstream with regard to at least one through-flow path, such that heat from the more intensely heated portion is transferred by thermal conduction to the less intensely heated portion.

In particular, provision may here be made for a portion of the catalyst flow element heated more intensely with regard to a through-flow path and a portion of the catalyst flow element heated less intensely with regard to the same through-flow path to be arranged adjacent one another, such that heat from the more intensely heated portion is transferred by thermal conduction to the less intensely heated portion. In particular, provision may be made for the two portions of the catalyst flow element to be arranged laterally adjacent one another with regard to a through-flow direction.

Alternatively or in addition, provision may be made for the catalyst flow element to comprise at least one more intensely heated portion, which is arranged downstream with regard to a through-flow path and adjacent, in particular laterally adjacent with regard to a through-flow direction, to at least one less intensely heated portion of the catalyst flow element arranged upstream with regard to another through-flow path.

It may be advantageous for the heat from the more intensely heated portion to be transferred to the less intensely heated portion in a direction which is substantially transverse to at least one through-flow direction of the more intensely heated portion and/or substantially transverse to at least one through-flow direction of the less intensely heated portion. The heat is thus preferably not transferred along the through-flow path, but rather mainly transverse to at least one through-flow direction from the more intensely heated portion to the less intensely heated portion.

Provision may be made for the gas stream to be enriched with chemically reactive constituents for generating heat prior to said gas stream being supplied to the catalyst flow element.

In particular, provision may here be made for the gas stream to be an exhaust gas stream from a combustion engine, wherein the combustion engine is open- and/or closed-loop controlled for example by means of a control device in such a way that the concentration and/or the quantity of the oxidizable and/or oxidizing substances contained in the gas stream is increased.

Alternatively or in addition, provision may be made for chemically reactive constituents to be supplied to the gas stream.

By enriching the gas stream with chemically reactive constituents, the quantity of heat obtainable by exothermic reaction in the catalyst flow element may be increased, for example so as to be able to heat the gas stream to be supplied to the purification flow element and thus also the purification flow element itself to a desired temperature.

The purification device for purifying a crude gas stream comprises the following:

a catalyst flow element preferably according to the invention, through which a gas stream is configured to be passed, wherein heat is generable through chemical reactions of constituents of the gas stream during through-flow of the catalyst flow element, such that the catalyst flow element is heatable along at least one through-flow path and in this way at least one more intensely heated portion of the catalyst flow element, arranged downstream with regard to at least one through-flow path, and at least one less intensely heated portion of the catalyst flow element, arranged upstream with regard to at least one through-flow path, are producible;

a flow guide, by means of which the gas stream flowing into the catalyst flow element for heating said gas stream is suppliable at least to a portion of the catalyst flow element which is heatable on the basis of through-flow by the gas stream and the ensuing chemical reactions of the constituents of the gas stream; and

a purification flow element, to which the gas stream guided by the catalyst flow element and heated therein is suppliable to heat the purification flow element.

Such a purification device is preferably efficiently and reliably operable.

The purification device preferably comprises a control device, such that individual ones or a plurality of the described method steps are in particular automatically performable.

At least a proportion of the gas stream flowing into the catalyst flow element, to heat said gas stream, is configured to be brought into direct contact preferably with at least one more intensely heated portion of the catalyst flow element by means of the flow guide during the inflow process.

Alternatively or in addition, provision may be made for at least a proportion of the gas stream flowing into the catalyst flow element, to heat said gas stream, to be configured to be brought into indirect contact with at least one more intensely heated portion of the catalyst flow element by means of the flow guide during the inflow process. In particular, provision may here be made for at least a proportion of the gas stream flowing into the catalyst flow element, to heat said gas stream, to be configured to be brought into direct contact with at least one less intensely heated portion of the catalyst flow element by means of the flow guide during the inflow process, which portion is in turn heatable by means of a more intensely heated portion, such that heat may be transferred to the inflowing gas stream.

In one embodiment of the invention provision is made for at least one through-flow path in the catalyst flow element to be of meandering configuration.

In this description and the appended claims, a meandering through-flow path should be understood to mean in particular a through-flow path which extends in places in a first spatial direction, which forms a first through-flow direction, and in places at least approximately contrary to the first spatial direction, such that a second through-flow direction is formed which is at least approximately opposite to the first through-flow direction.

Preferably, a meandering through-flow path forms through-flow path portions of the same through-flow path, which directly adjoin one another spatially, in particular are arranged laterally next to one another with regard to the through-flow directions.

Preferably, the spatially directly adjoining through-flow path portions are arranged spaced from one another with regard to the through-flow path, in particular one behind the other and spaced from one another with regard to the through-flow path.

It may be favorable for at least one through-flow path to have an uneven number of through-flow path portions with alternating through-flow directions. Provision may for example be made for at least one through-flow path to have three through-flow path portions, which are arranged spatially next to one another, but with regard to the through-flow path are arranged one behind the other and have alternating through-flow directions.

It may be advantageous for the purification device to comprise a catalytic intermediate flow element, through which the gas stream guided by the catalyst flow element is configured to be passed prior to supply thereof to the purification flow element. In this way, an additional temperature increase in the gas stream may be achieved prior to supply thereof to the purification flow element.

In particular, provision may be made for the catalytic intermediate flow element to have a structure different from the catalyst flow element and/or a composition, in particular coating, different from the catalyst flow element, such that additional chemical reactions of the constituents of the gas stream may be induced by means of the catalytic intermediate flow element.

The flow guide is preferably configured in such a way that the gas stream is configured to be supplied initially to the catalytic flow element, then optionally to the catalytic intermediate flow element and then to the purification flow element.

It may be favorable for the catalyst flow element to comprise a ceramic material and/or a metallic material or to be formed of a ceramic material or of a metallic material.

In particular, provision may be made for the catalyst flow element to comprise a main body of a ceramic material, which is filled with a metallic material, for example with metal foam.

The catalyst flow element preferably comprises a plurality of flow channels. The flow channels are preferably formed in the main body of the catalyst flow element.

Provision may be made for the flow channels to be filled at least in part with a metal foam. In this way, heat transfer from the catalyst flow element to the gas stream flowing through the catalyst flow element and/or from the gas stream flowing through the catalyst flow element to the catalyst flow element may be improved.

The catalytic intermediate flow element preferably possesses individual ones or a plurality of the features and/or advantages described in connection with the catalyst flow element.

In one embodiment of the invention, provision is made for the catalyst flow element to comprise a plurality of flow channels which extend substantially parallel to one another.

At least two flow channels arranged adjacent one another are preferably configured for through-flow of at least a proportion of the gas stream in mutually opposing through-flow directions.

It may be favorable for the catalyst flow element to be configured as an element with honeycomb structure. This honeycomb structure element preferably comprises honeycomb cells of for example rectangular cross-section, which preferably form the flow channels.

The flow channels are preferably of substantially linear construction and/or arranged parallel to one another.

It may be favorable for at least two flow channels arranged laterally adjacent one another with regard to at least one through-flow direction to form through-flow path portions of the same through-flow path.

Provision may for example be made for three flow channels to be arranged adjacent one another and to form three through-flow path portions of a through-flow path, such that the gas stream guided through the flow channels is guidable initially along a first through-flow path portion in a first through-flow direction from an inlet side of the catalyst flow element to the outlet side opposite the inlet side, then in a second through-flow direction opposite to the first through-flow direction through the second through-flow path portion back to the inlet side and in the first through-flow direction through the third through-flow path portion back to the outlet side.

The through-flow path portions adjoining one another with regard to the through-flow path are preferably connected fluidically together at their respective ends (common end region), wherein the gas stream is prevented from escaping into the surrounding environment in the region of the joint (common end region) between the through-flow path portions preferably by a suitable seal (channel closure).

The purification device is suitable in particular for purifying an exhaust gas stream.

The gas stream is preferably an exhaust gas stream of a combustion engine, for example a lean burn engine.

Provision may further be made for the purification flow element to be a particulate filter, in particular a diesel exhaust particulate filter.

The purification device is thus in particular an exhaust gas aftertreatment device.

The purification flow element is preferably passively regenerable.

The purification device may moreover comprise an NOₓ storage catalyst (LNT).

The purification device is suitable preferably for both stationary and mobile applications. For example, the purification device may be used in vehicles, in particular in ground vehicles.

In addition, the method according to the invention, the catalyst flow element according to the invention and/or the purification device according to the invention may comprise individual ones or a plurality of the features and/or advantages described below:

A feed device for introducing at least one additive into the gas stream may be provided. In particular, the feed device may be configured to introduce oxidizable and/or oxidizing substances into the gas stream, in order to increase the quantity and/or concentration of the chemically reactive constituents in the gas stream.

It may be favorable for at least one bypass device to be provided, by means of which at least a proportion of the gas stream is configured to be guided past at least one catalyst flow element, a catalytic intermediate flow element and/or the purification flow element, without flowing through the at least one catalyst flow element, the catalytic intermediate flow element and/or the purification flow element.

The catalyst flow element may for example be configured as an oxidation catalyst (DOC).

The heating method may preferably be performed for any desired low gas stream temperature (inlet temperature). It is preferably necessary merely to establish a gas stream temperature at the start of the method which is above a limit temperature from which the chemically reactive constituents in the gas stream react together exothermically. The method then preferably makes continuous operation possible without external energy input and/or preheating.

The increase in gas temperature to a value above the limit temperature at the start of the method may proceed for example by auxiliary measures, in particular by suitable control of a combustion device, in particular a combustion engine, or of an auxiliary burner, by throttling the combustion device, in particular the internal combustion engine, and/or electrically.

The purification flow element is for example a filter device made of a porous ceramic material with high thermal shock resistance, for example cordierite or silicon carbide (SiC).

Alternatively or in addition, provision may be made for the purification flow element to be made from a porous sintered material.

It may be favorable for the catalyst flow element, the catalytic intermediate flow element and/or the purification flow element to be provided with a catalytic coating, for example based on iron, cerium, vanadium and/or platinum.

Alternatively or in addition, provision may be made for a fuel of the combustion device, in particular a fuel of the combustion engine, to be admixed with catalytically active constituents, in particular based on iron, cerium, vanadium and/or platinum.

The catalyst flow element, the catalytic intermediate flow element and/or the purification flow element may for example comprise a main body with a ceramic or metallic support structure and an active, catalytic coating with a high platinum content.

Preferably the catalyst flow element, the catalytic intermediate flow element and/or the purification flow element comprise a main body, which is provided with mutually parallel flow channels, with structured channel shapes, which comprise openings and deflections for example, with woven fabrics, with knitted fabrics, with filling charges and/or with a foam-type structure.

Preferably, the catalyst flow element, the catalytic intermediate flow element and/or the purification-flow element comprise parallel channels, which have low pressure loss.

To increase the temperature of the gas stream supplied to the catalyst flow element, provision may be made for a combustion device, in particular a combustion engine, to be suitably open- and/or closed-loop controlled by means of a control device. In particular, intake throttling, measures with regard to a turbocharger or exhaust gas recirculation and/or post-injection of additional fuel may be provided in this respect.

Alternatively or in addition, provision may be made for the purification flow element, the catalytic intermediate flow element and/or the catalyst flow element to be electrically heated.

Additives which may be supplied by means of the feed device are for example motor fuel, in particular diesel fuel, ethanol, glycol, propane, butane and/or ethylene. Alternatively or in addition, catalytic petrol and/or isopropyl alcohol may also be supplied.

To improve mixing of the additives introduced into the gas stream, provision may be made for at least one static mixer to be provided. In particular, provision may in this respect be made for at least one static mixer to be arranged in a supply line.

During regeneration of the purification flow element, the gas stream is enriched, for example by engine-related measures, preferably by carbon monoxide and hydrocarbons.

By means of the control device, open- or closed-loop control may preferably be exerted over the quantity and/or concentration of the additives introducible by means of the feed device, in particular as a function of a detected load and/or exhaust gas throughput signal from a combustion engine and/or the temperature of the gas stream before and/or after through-flow of the catalyst flow element.

To increase heat transfer from the gas stream to the catalyst flow element and/or from the catalyst flow element to the gas stream, provision may made for at least one flow channel of the catalyst flow element to be provided with projections and/or indentations, for example with so-called “folded-out” vanes, which bring about turbulent through-flow of the catalyst flow element, in particular break up laminar flow, which would form without such projections and/or indentations.

The method according to the invention and/or the devices according to the invention, in particular the catalyst flow element according to the invention, preferably further possess individual ones or a plurality of the features described below:

Flow channel deflection preferably occurs within the main body and/or is adapted to the structure of the main body, in particular a honeycomb structure, for example a honeycomb microstructure. An external deflecting element is thus preferably unnecessary.

Through suitable arrangement of the flow channels, the slots and/or the channel closures, preferably 5/6 of the surface area of the channel walls may be used as heat exchange surfaces.

The catalyst flow element according to the invention may preferably be produced inexpensively with the same production means as diesel exhaust particulate filters.

Further preferred features and/or advantages of the catalyst flow element according to the invention, the purification device according to the invention, the thermal engine according to the invention and/or the methods and/or uses according to the invention constitute the subject matter of the following description and drawings of exemplary embodiments.

### BRIEF DESCRIPTION OF THE DRAWINGS

FIG. 1 shows a schematic horizontal longitudinal section through a catalyst flow element;

FIG. 2 is a schematic plan view onto an inlet side of the catalyst flow element;

FIG. 3 shows a schematic longitudinal section through the catalyst flow element along line 3-3 in FIG. 2;

FIG. 4 is a schematic plan view corresponding to FIG. 2 onto the inlet side of the catalyst flow element, individual partition walls of the catalyst flow element being provided with slots;

FIG. 5 is a schematic plan view corresponding to FIG. 4 onto an outlet side of the catalyst flow element, individual partition walls likewise being provided with slots;

FIG. 6 is a schematic sectional representation corresponding to FIG. 3 of the catalyst flow element, individual partition walls being provided with slots in accordance with FIGS. 4 and 5;

FIG. 7 is a schematic plan view corresponding to FIG. 4 onto the inlet side of the catalyst flow element, pairs of flow channels of the catalyst flow element being provided with channel closures;

FIG. 8 is a schematic plan view corresponding to FIG. 5 onto the outlet side of the catalyst flow element, pairs of flow channels likewise being provided with channel closures in accordance with the inlet side in FIG. 7;

FIG. 9 is a schematic representation corresponding to FIG. 6 of the catalyst flow element, pairs of flow channels being provided with channel closures in accordance with FIGS. 7 and 8;

FIG. 10 shows a schematic section through the catalyst flow element provided with slots and channel closures along line 10-10 in FIG. 11;

FIG. 11 is a schematic representation corresponding to FIG. 9 of the catalyst flow element to illustrate through-flow paths;

FIG. 12 is a schematic representation of a purification device for purifying a crude gas stream, in which a catalyst flow element and a purification flow element are provided; and

FIG. 13 is a schematic representation of a thermal engine, in which a catalyst flow element is arranged between a combustion device and a turbine device.

Identical or functionally equivalent elements are provided with the same reference signs in all the figures.

### DETAILED DESCRIPTION OF THE DRAWINGS

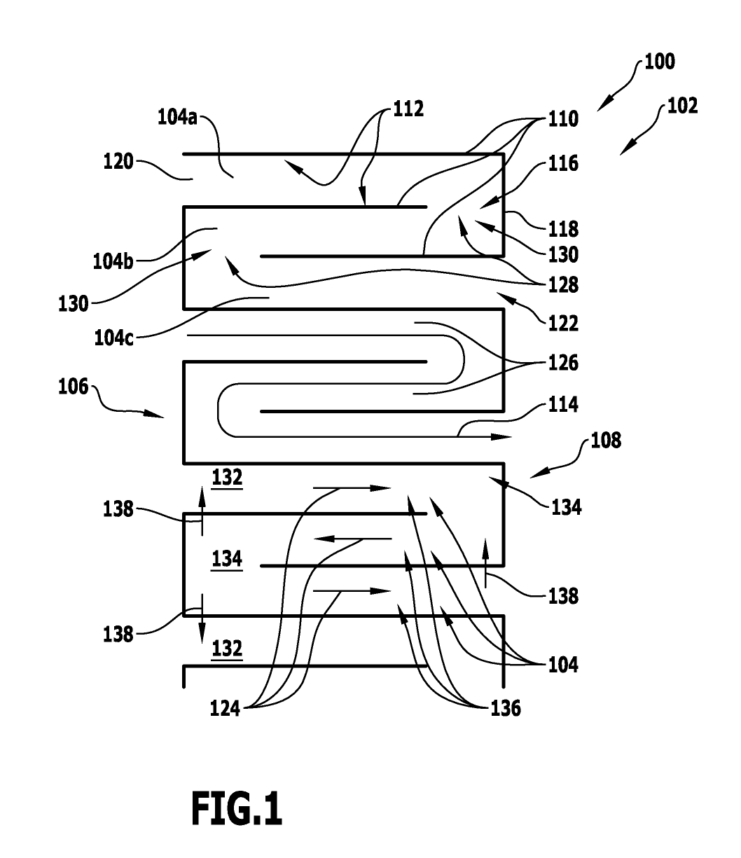

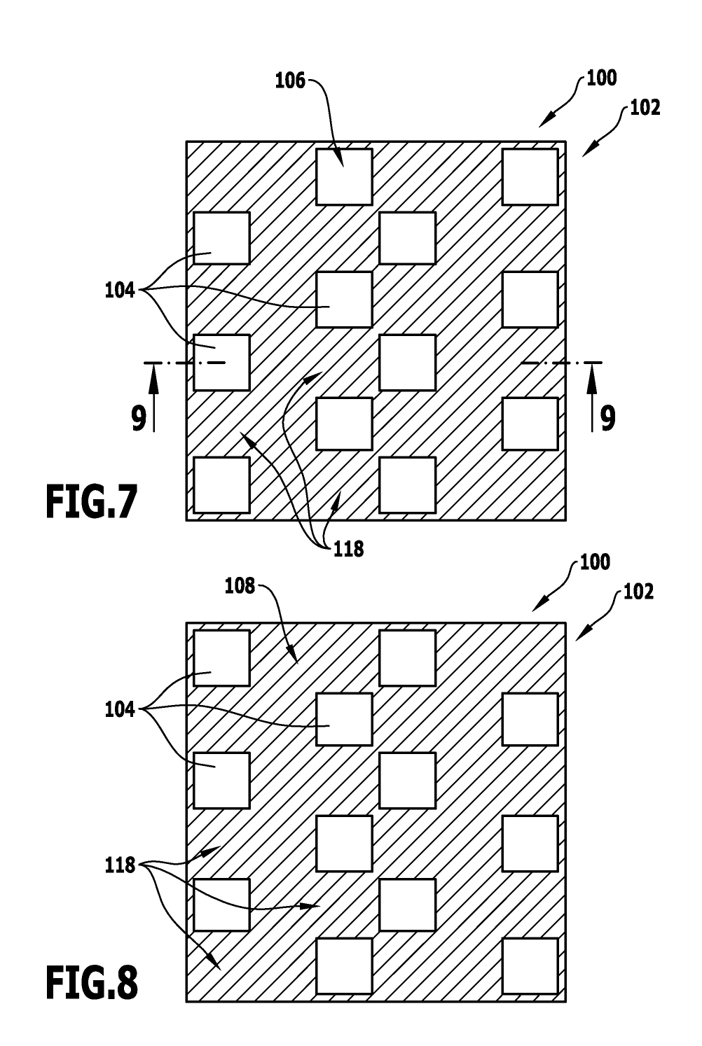

A catalyst flow element illustrated in FIGS. 1 to 11 and designated overall as 100 comprises a main body 102, which is substantially cuboidal or cylindrical and comprises a plurality of flow channels 104.

The flow channels are substantially cylindrical with a square base area and arranged in the manner of a matrix in a square pattern and parallel to one another.

The flow channels 104 extend from an inlet side 106 of the main body 102 to an outlet side 108 of the main body 102.

Partition walls 110 are arranged between the flow channels 104.

The main body 102 is in particular a honeycomb structure with square cross-section and square honeycomb cells.

The main body 102 is provided with a catalytic coating 112, such that reactions of a gas flowing through the main body 102 may be specifically influenced.

A plurality of meandering through-flow paths 114 are formed in the catalyst flow element 100 by means of the flow channels 104.

To this end, in each case three flow channels 104 are connected fluidically together.

The partition wall 110 between a first flow channel 104a and a second flow channel 104b is to this end provided with a slot 116 on the outlet side 108 of the main body 102, such that a fluidic connection between the first flow channel 104a and the second flow channel 104b is produced within the main body 102.

Both the first flow channel 104a and the second flow channel 104b are sealed on the outlet side 108 by means of a channel closure 118, such that gas flowing through the first flow channel 104a and the second flow channel 104b cannot flow out of the main body 102 directly out of the first flow channel 104a or the second flow channel 104b on the outlet side 108 of the main body 102.

The second flow channel 104b is moreover fluidically connected on the inlet side 106 of the main body 102 with a further flow channel 104, namely a third flow channel 104c. To this end, a further slot 116 is provided in the partition wall 110 between the second flow channel 104b and the third flow channel 104c on the inlet side 106 of the main body 102.

The second flow channel 104b and the third flow channel 104c are sealed with a further channel closure 118 on the inlet side 106 of the main body 102. Gas flowing through the second flow channel 104b and the third flow channel 104c thus cannot flow out of the main body 102 directly out of the second flow channel 104b or the third flow channel 104c on the inlet side 106 of the main body 102.

The first flow channel 104a is open towards the inlet side 106 of the main body 102, so as to form an inlet orifice 120 of the main body 102.

The third flow channel 104c is open on the outlet side 108 of the main body 102, so as to form an outlet orifice 122 of the main body 102.

The first flow channel 104a, the second flow channel 104b and the third flow channel 104c form a through-flow path 114, along which gas flowing into the main body 102 may flow through the main body 102 and finally back out of the main body 102.

The through-flow path 114 is of meandering configuration since, owing to the fluid connection of the first flow channel 104a and the second flow channel 104b and the channel closure 118 in the region of the outlet side 108 of the main body 102, an inflowing gas stream is deflected in one through-flow direction 124 after flowing through the first flow channel 104a and is guided contrary to this through-flow direction 124 through the second flow channel 104b back to the inlet side 106 of the main body 102. Furthermore, the gas stream flowing through the main body 102 is deflected again by means of the fluid connection between the second flow channel 104b and the third flow channel 104c and the channel closure 118 in the region of the inlet side 106 of the main body 102, such that, after flowing through the second flow channel 104b, it flows again in the reverse through-flow direction through the third flow channel 104c. The gas stream may finally leave the main body 102 through the outlet orifice 122.

A flow deflection 128 may thus be formed by means of a pair 126 of flow channels 104, a slot 116 in a partition wall 110 separating the flow channels 104 from one another and a channel closure 118 sealing the flow channels 104.

A meandering through-flow path 114 may be formed by means of two flow deflections 128 and using three adjacent flow channels 104.

In this case, the slots 116 and channel closures 118 are always arranged in a common end region 130 of the pair 126 of flow channels 104.

All the inlet orifices 120 of the catalyst flow element 100 are arranged on the inlet side 106.

All the outlet orifices 122 of the catalyst flow element 100 are arranged on the outlet side 108.

On through-flow of the catalyst flow element 100 by a reactive gas stream along the through-flow path 114, the gas stream heats up due to exothermic reactions of constituents of the gas stream. The catalyst flow element 100 is also heated thereby.

Since the evolution of heat increases over the through-flow path 114, each of the flow channels 104 has a less intensely heated portion 132 arranged upstream with regard to the through-flow path 114 and a more intensely heated portion 134 arranged downstream with regard to the through-flow path 114. In this respect, the flow channels 104 form through-flow path portions 136 of the through-flow path 114.

Owing to the adjacent arrangement of the flow channels 104, heat from a more intensely heated portion 134 of a through-flow path portion 136 may be transferred to a less intensely heated portion 132 of another through-flow path portion 136.

For example, heat from the more intensely heated portion 134 of the second flow channel 104b, which is arranged on the inlet side 106 of the catalyst flow element 100, may be transferred to the less intensely heated portion 132 of the first flow channel 104a, likewise arranged on the inlet side 106 of the catalyst flow element 100.

In this way, the region of the first flow channel 104a, into which the gas stream flowing into the catalyst flow element 100 flows, may be specifically heated, in order also to heat up the gas stream itself.

Heat from the more intensely heated portion 134 of the second flow channel 104b is thus transferred to the gas stream flowing into the catalyst flow element 100.

The heat transferred from the more intensely heated portions 134 to the less intensely heated portions 132 is preferably transferred in a heat transfer direction 138 which is substantially transverse, in particular substantially perpendicular, to the through-flow direction 124 in the individual flow channels 104.

As a result of the internal heat transfer in the catalyst flow element 100, it is thus preferably possible to prevent the reaction in the catalyst flow element 100 from terminating due to an excessively low a temperature of the inflowing gas stream.

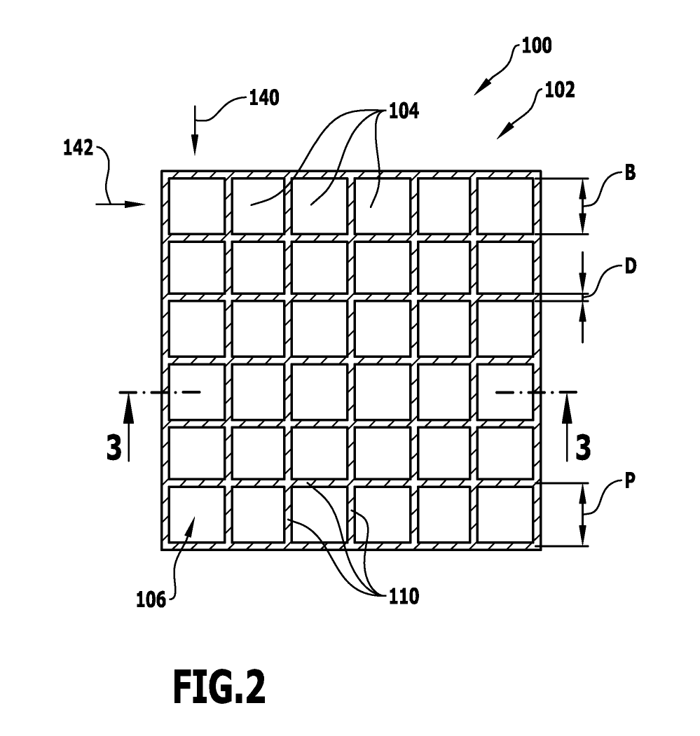

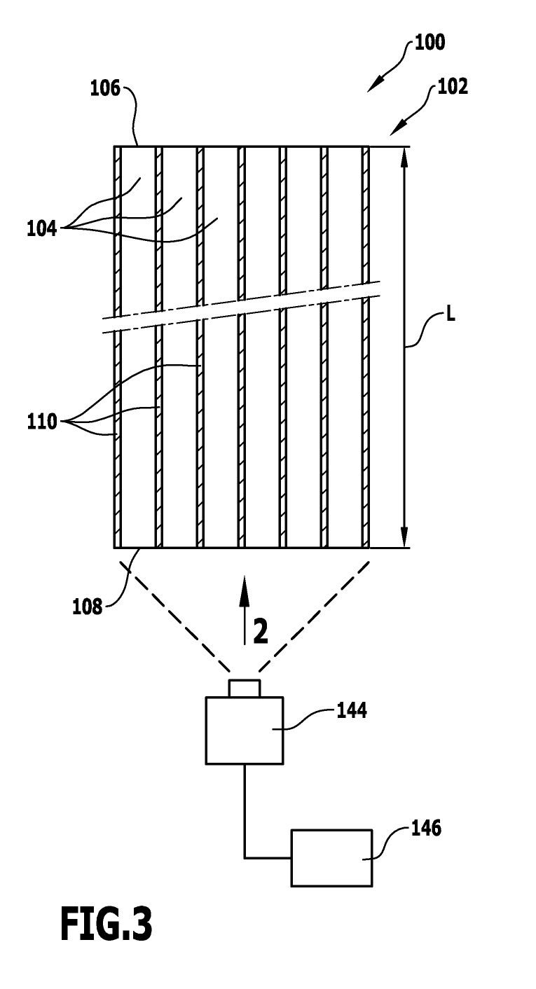

As may be derived in particular from FIGS. 2 and 3, in an initial state, in which as yet no slots 116 and no channel closures 118 have been provided, the main body 102 is in particular a honeycomb structure with cylindrical honeycomb cells of square cross-section arranged in the manner of a matrix.

The main body 102 may for example be extruded from a malleable ceramic composition, which preferably comprises cordierite. The cell size (flow channel size) and wall thickness (thickness of the partition walls 110) are in principle freely selectable. Preferably 100, 200 or 300 flow channels are provided per square inch (cells per square inch).

An open cross-section resulting from the ratio of the thickness D of the partition wall (cell wall) and the center distance of two adjacent partition walls extending parallel to one another (so-called pitch P) according to the formula (pitch−partition wall thickness)²/(pitch)², preferably amounts to roughly 70%.

The number of flow channels 104 per column 140 and/or row 142 is preferably integrally divisible by three. The number of flow channels 104 in a column 140 is preferably identical to the number of flow channels 104 in a row 142. The cross-section of the main body 102 (honeycomb cross-section) is thus preferably square.

The length L of the main body 102 preferably amounts to forty to fifty times the magnitude of the pitch P.

The material of the main body 102, in particular cordierite, preferably has good extrudability, a low coefficient of thermal expansion and high thermal and mechanical stability. The coefficient of thermal conduction is preferably sufficiently high to allow heat transfer through the partition walls.

Once the main body 102 has been extruded and cut off in a soft state, the main body 102 is dried by freeze drying and then cut to dry length. The dry, unfired main bodies 102 are sufficiently stable to be handled and soft enough for further mechanical processing.

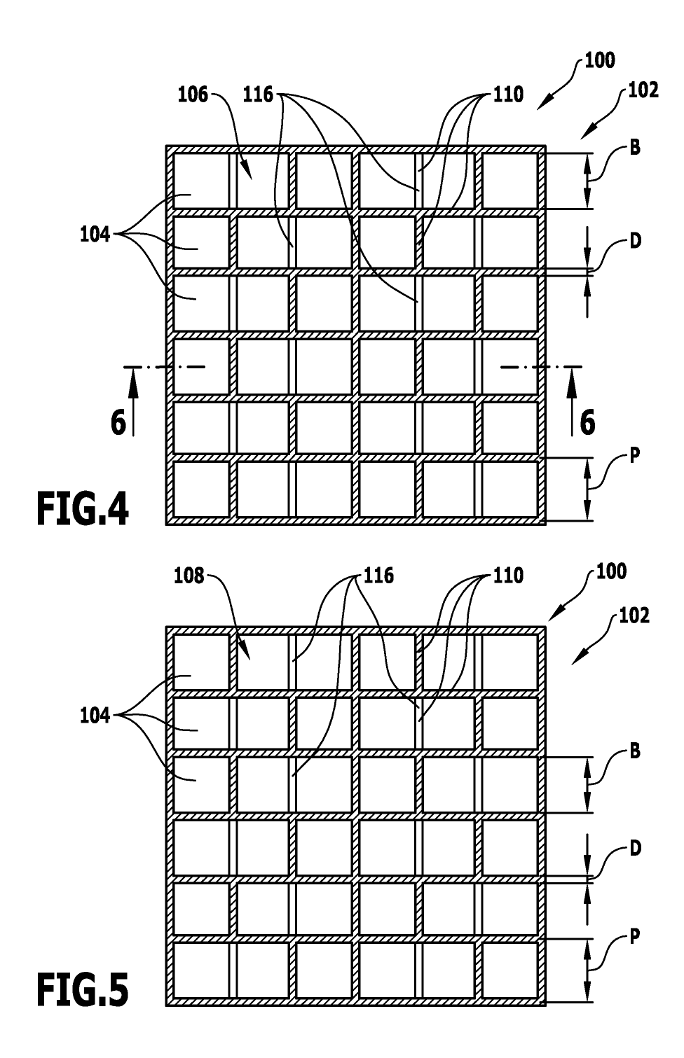

As may be derived in particular from FIGS. 4 to 6, the main body 102 is further processed by the introduction of slots 116.

To this end, as shown in FIG. 3, an image recording device 144 and an image analysis device 146 are used to determine the position of the partition walls 110, to enable the deliberate and reliable introduction of individual slots 116 into the partition walls 110.

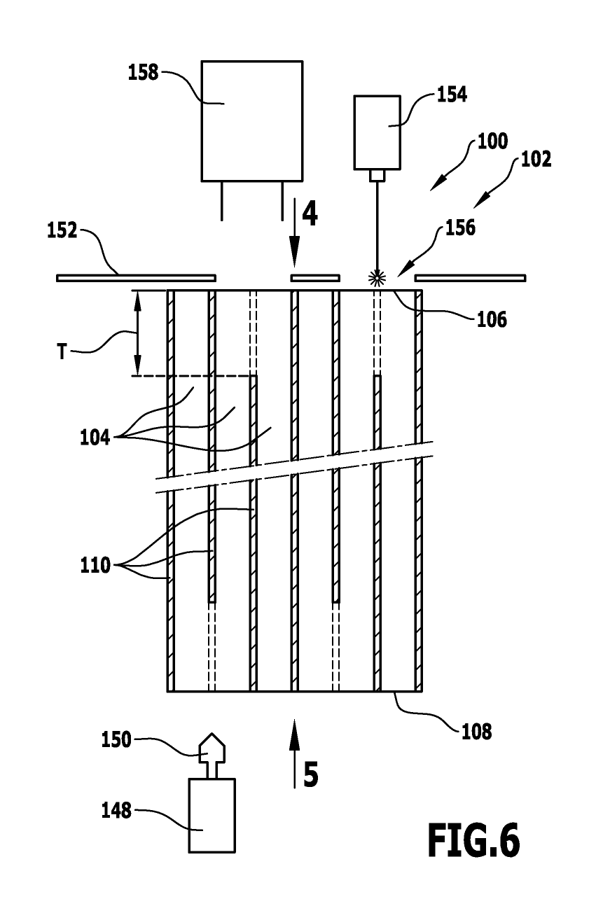

The data generated by means of the image recording device 144 and the image analysis device 146 are transmitted to a milling device 148, in particular a CNC-controlled milling device (see FIG. 6).

Using the milling device 148, the slots 116 are milled into the partition walls 110.

A milling head 150 of the milling device 148 preferably has a diameter which corresponds substantially to the width B of the flow channels 104.

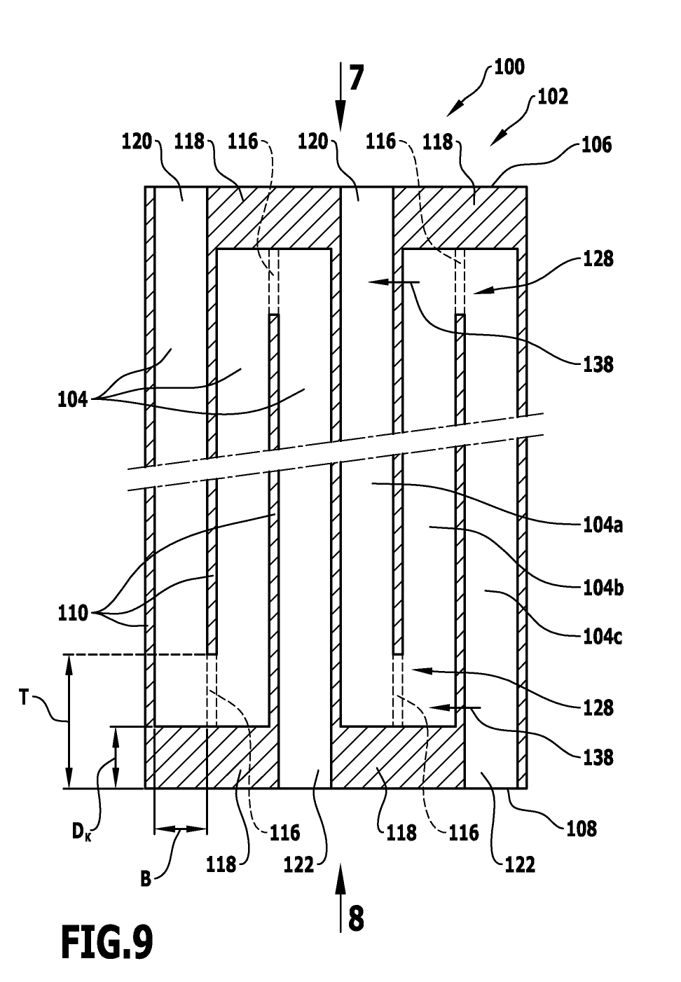

The milling depth T is here preferably established so as to correspond at least to the sum of the width B of the flow channels 104 and the thickness D_{K} of the channel closures 118 (see FIG. 9).

Once the slots 116 have been introduced, the main body 102 is fired, for example at around 1300° C. In this way, the main body 102 in particular obtains the mechanical properties necessary for a catalyst device.

In a next step, the main body 102 is provided with the catalytic coating 112. This is preferably achieved using a dipping method, in which a liquid composition containing noble metal is applied.

After drying of the main body 102 and calcining thereof at around 400° C., the main body 102 may be further processed.

As is revealed in particular in FIG. 6, the inlet side 106 and additionally also the outlet side 108 are provided with a mask 152.

The mask 152 is here produced by adhesively bonding a transparent plastics film to the inlet side 106 or the outlet side 108. Using the image recording device 144 and the image analysis device 146, the positions of the slots 116 and thus also of the channel closures 118 are then determined. The data obtained in this way are used to control a laser device 154, in order to burn away the plastics film at those points where the channel closures 118 are to be arranged. In this way, the mask 152 is produced with the necessary openings 156.

Using a filling device 158, for example a ceramic composition dispenser, malleable material, in particular malleable ceramic material, is introduced through the openings 156 in the mask 152 into the flow channels 104 of the main body 102 accessible through the openings 156 in the mask 152.

The material which is introduced preferably corresponds to the material of the main body 102 and thus preferably has substantially the same coefficient of thermal expansion.

To solidify the material and thus to finish the channel closures 118, a drying and calcining process is performed at around 500° C.

A plurality of main bodies 102 produced in this way may then be combined, in particular adhesively bonded, to form larger assemblies (blocks).

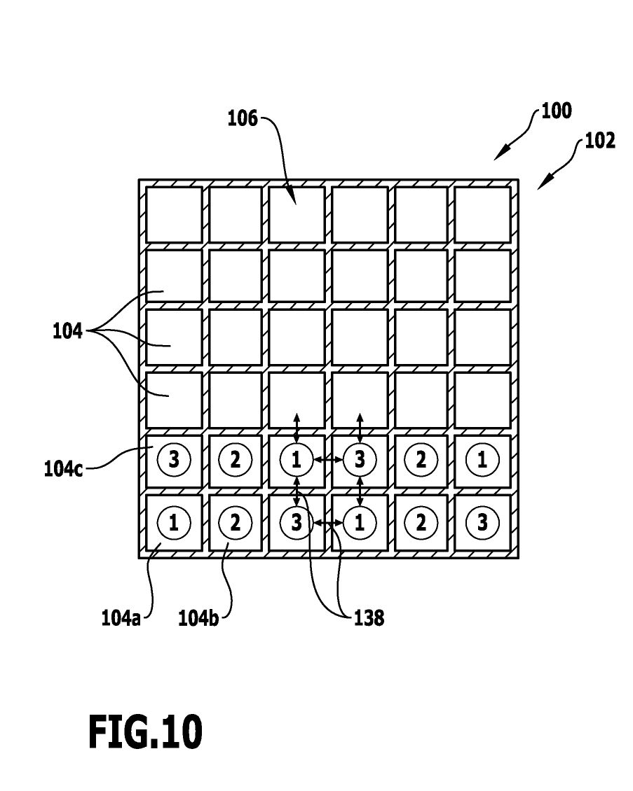

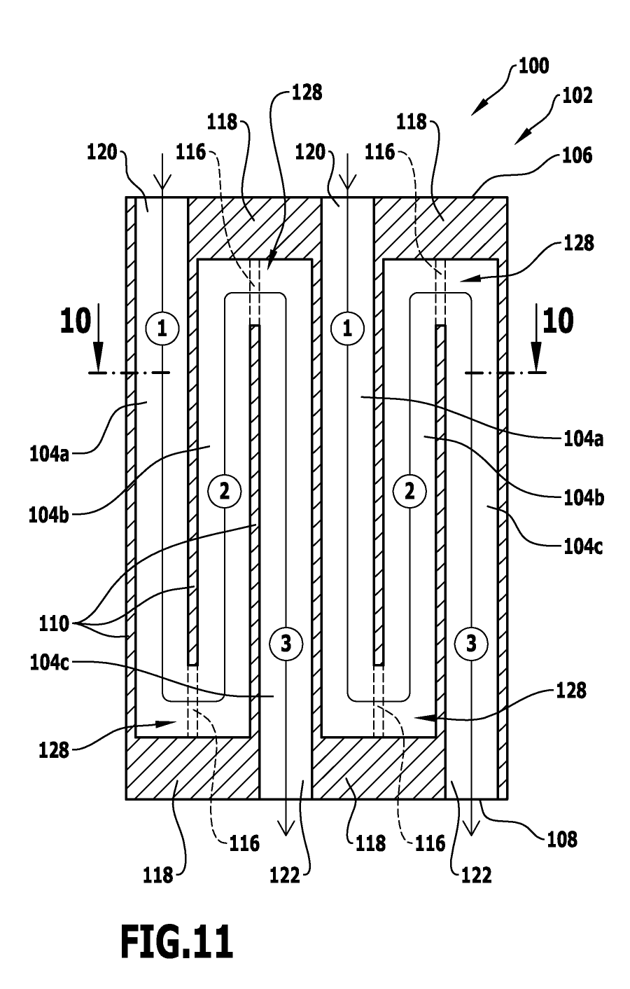

As may be derived in particular from FIGS. 10 and 11, the slots 116 and the channel closures 118 are preferably arranged in such a way that the flow channels 104a through which a gas stream flowing through the main body 102 flows into the main body 102 (labeled “1” in FIGS. 10 and 11) and the flow channels 104c through which the gas stream flows out of the main body 102 (labeled “3” in FIGS. 10 and 11) are arranged at least in places in a chequered pattern.

In this way, in the event of horizontal through-flow, heat transfer may take place for example both in the horizontal and the vertical heat transfer direction 138 perpendicular to the through-flow direction 124.

The flow channels 104 (104b) which are closed on both sides, labeled “2” in FIGS. 10 and 11, and arranged between the flow channels 104 (104a, 104c, “1”, “3”) open on the inlet side 106 or the outlet side 108 respectively are arranged in columns.

The at least partly chequered pattern of the flow channels 104a, 104c which are open to the inlet side 106 or to the outlet side 108 of the main body 102 results from the row-wise alternating arrangement of the flow channels 104 with the slots 116 and the channel closures 118. Thus, rows in which the flow channels are arranged in the sequence 1-2-3-1-2-3 etc. alternate with rows in which the arrangement is 3-2-1-3-2-1 etc..

The slots 116 and the channel closures 118 on the inlet side 106 are preferably diametrically opposed, in particular point-symmetrically, to the slots 116 and the channel closures 118 on the outlet side 108.

The two-fold flow deflection 128 per through-flow path 114 allows the gas stream flowing through the main body 102 to flow in on the inlet side 106 and to flow out on the outlet side 108, which is arranged opposite the inlet side 106.

In principle, states may arise in a catalyst in which the catalytic heat output generated is so high that heat dissipation can no longer be guaranteed and the catalyst is destroyed.

In the catalyst flow element described, this risk is very low, since the heat generated catalytically in a flow channel 104 is output immediately to adjacent flow channels 104. Furthermore extinction of the catalyst flow element 100 may hereby be prevented, since the inflowing gas stream is heated by means of heat transfer to the inlet orifices 120, in particular to above the catalytic ignition temperature, even when a gas inlet temperature drops below the catalytic ignition temperature.

Thus, a catalyst flow element 100 operated with vaporized diesel fuel, in which a catalytic ignition temperature of between around 200° C. and around 250° C. is required, may be operated after ignition with a gas inlet temperature of as low as around 80° C. without extinction of the catalyst flow element 100, i.e. without combustion of the diesel fuel in the catalyst flow element 100 ceasing. Particularly when using the catalyst flow element 100 to heat a further device, for example a purification flow element (still to be described), it is thereby possible in any case to achieve a required outlet temperature, for example a regeneration temperature for regenerating a diesel exhaust particulate filter, of 550° C.

Hotter and colder zones preferably move about in an oscillating manner in the catalyst flow element. In this way, a longer service life and better overall activity of the catalyst flow element 100 may preferably be achieved.

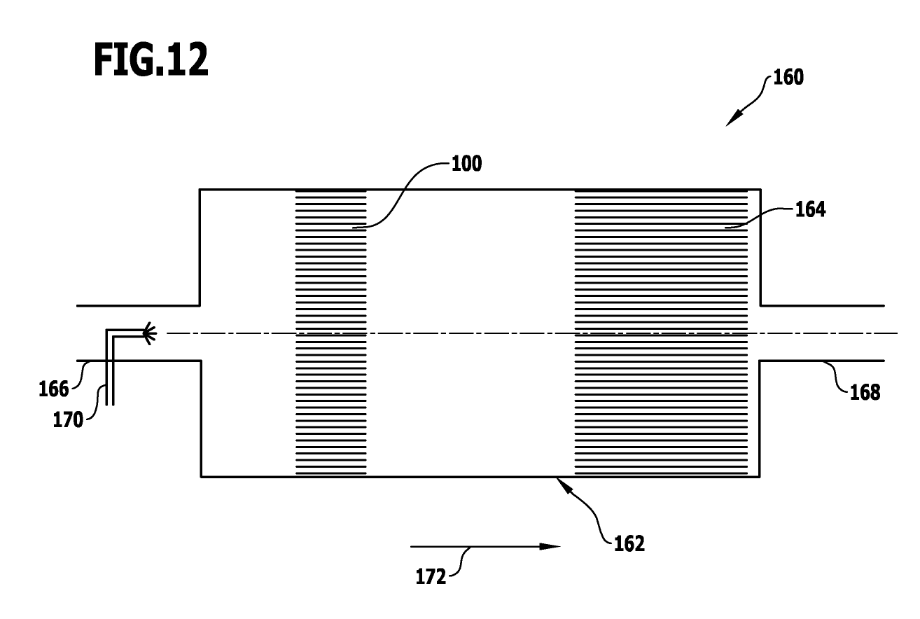

FIG. 12 shows a purification device designated overall as 160.

The purification device 160 comprises a housing 162, in which a catalyst flow element 100 and a purification-flow element 164, in particular a diesel exhaust particulate filter, are arranged.

The housing 162 is provided with an inlet 166 and an outlet 168.

In addition, a feed device 170 is provided for introducing an additional material, in particular fuel.

With regard to a through-flow direction 172 of the purification device 160, the inlet 166, the feed device 170, the catalyst flow element 100, the purification flow element 164 and the outlet 168 are arranged in succession.

A gas stream guided through the purification device 160, in particular an exhaust gas stream of a diesel-driven internal combustion engine, may consequently be supplied via the inlet 166 of the purification device 160.

The feed device 170 may be used to enrich the gas stream for example with additional fuel, in particular diesel fuel.

The gas stream is then guided through the catalyst flow element 100 and finally purified in the purification flow element 164, with diesel exhaust particulates in particular being separated at this point.

The purified exhaust gas stream then leaves the purification device 160 via the outlet 168.

The purification device 160 described in FIG. 12 functions as follows:

In the course of operation a relatively large quantity of diesel exhaust particulates is gradually deposited in the purification flow element 164.

If this deposition makes flow resistance too great, the purification flow element 164 must be burned off.

This proceeds by heating thereof by means of the catalyst flow element 100.

The exhaust gas guided into the purification device 160 is to this end enriched with fuel for example by means of the feed device 170, the fuel being oxidized by means of the catalyst flow element 100 to generate heat.

The heat generated by means of the catalyst flow element 100 leads to intense heating of the purification flow element 164, whereby the diesel exhaust particulates separated therein are combusted. The purification flow element 164 is regenerated hereby and may be put to further use.

The use in particular of meandering through-flow paths 114 in the catalyst flow element 100 (see in particular FIG. 1) enables reliable heating of the purification flow element 164 and thus reliable regeneration thereof and reliable operation of the purification device 160.

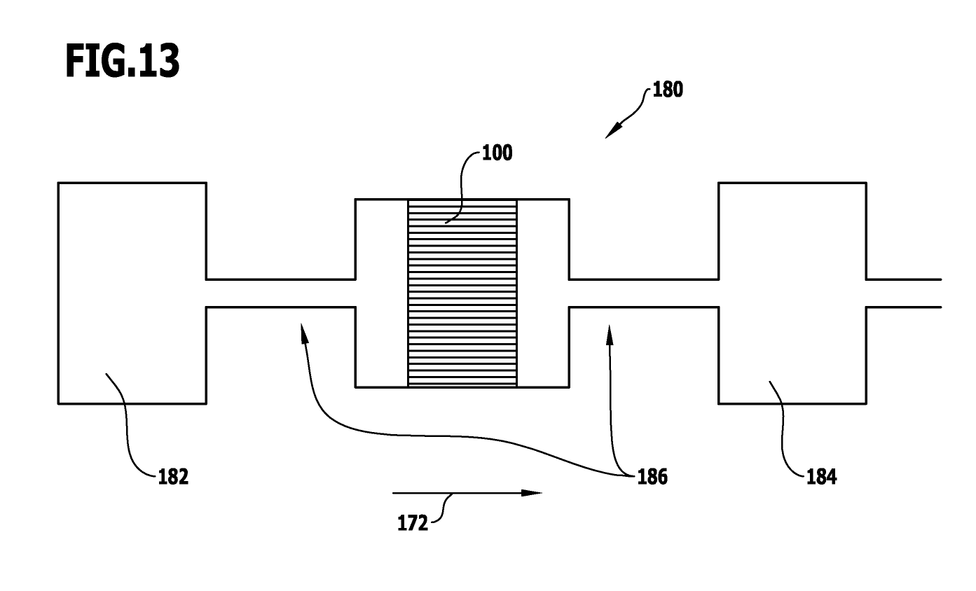

A thermal engine 180 illustrated in FIG. 13 comprises a combustion device 182, in particular a combustion engine, a turbine device 184, in particular a turbocharger device, a catalyst flow element 100 and an exhaust gas flow guide 186.

The combustion device 182, the turbine device 184 and the catalyst flow element 100 are connected together fluidically by means of the exhaust gas flow guide 186, such that exhaust gas from the combustion device 182 may be supplied directly to the catalyst flow element 100, guided therethrough and then supplied to the turbine device 184.

In particular when using gas, in particular natural gas, as fuel for the combustion device 182 and with lean operation of the combustion device 182, undesired methane slip may occur.

The thermal engine 180 illustrated in FIG. 13 allows reliable removal of methane from the exhaust gas stream by using the catalyst flow element 100.

The catalyst flow element 100 is to this end coated for example with platinum, such that methane may be oxidized in the exhaust gas with an ignition temperature of around 500° C.

By using the catalyst flow element 100, for example according to FIG. 1, it is also possible through internal heat transfer to prevent the reaction in the catalyst flow element 100 from terminating in the event of the exhaust gas temperature of the combustion device 182 falling below 500° C.

The methane content in the exhaust gas is to this end preferably kept high enough for the system to be operable autothermally. For example a methane content of around 500 ppm may be established in the exhaust gas.

The arrangement of the catalyst flow element 100 upstream of the turbine device 184 assists in utilizing the higher exhaust gas temperatures for reliable combustion of the methane. Furthermore, the efficiency of the overall system may be increased thereby.

That which is claimed:

1. A method for producing a catalyst flow element, comprising:
providing a main body comprising a plurality of flow channels;
introducing slots into partition walls of the main body, which separate the flow channels from one another such that at least two adjacent flow channels are connected together fluidically within the main body in a common end region of the at least two adjacent flow channels;
arranging channel closures in the common end region for fluid-tight closure of the common end region while maintaining the fluidic connection between the at least two adjacent flow channels in the common end region.

2. The method according to claim 1, wherein the positions of the partition walls are determined prior to introduction of the slots using an image recording device and an image analysis device.

3. The method according to claim 1, wherein at least one of the slots or the channel closures are respectively introduced into the main body or arranged on the main body in a regular pattern.

4. The method according to claim 1, wherein at least one of the slots or channel closures are respectively introduced in such a way into the main body or arranged in such a way on the main body that horizontally adjacent flow channels and vertically adjacent flow channels are flowed through in mutually opposed through-flow directions when the catalyst flow element is in operation.

5. The method according to claim 1, wherein the slots are introduced into the main body distributed in such a way that on one side of the main body in each case two flow channels are connected together fluidically by means of one slot.

6. method according to claim 1, wherein the slots are introduced into the main body distributed in such a way that on one side of the main body in each case one pair of flow channels connected together fluidically by means of one slot is surrounded by four flow channels which directly adjoin the pair of flow channels and are not connected fluidically with further flow channels on this side of the main body.

7. The method according to claim 1, wherein the main body is provided on both sides with slots and channel closures.

8. The method according to claim 1, wherein in each case three flow channels are connected fluidically together by means of in each case two slots, which are arranged at mutually opposite end regions of the flow channels.

9. The method according to claim 1, wherein the slots are introduced into the main body and the channel closures are arranged on the main body in such a way that the flow channels of every third column or every third row of flow channels are provided on both sides with channel closures.

10. The method according to claim 1, wherein the main body is fired after introduction of the slots.

11. The method according to claim 1, wherein the main body is provided with a catalytic coating.

12 The method according to claim 1, wherein the main body is provided with a mask for the purpose of arranging the channel closures.

13. The method according to claim 1, wherein the flow channels are filled in part by means of a malleable material on arrangement of the channel closures.

14. The method according to claim 1, wherein the channel closures are joined to the main body by heating.

15. A catalyst flow element, comprising a main body which comprises the following:
an inlet side, on which a fluid stream may flow into the main body;
an outlet side opposite the inlet side, on which the fluid stream may exit from the main body; and
a plurality of meandering through-flow paths connecting the inlet side with the outlet side.

16. The catalyst flow element according to claim 15, comprising a main body which comprises the following:
a plurality of flow channels;
slots in partition walls of the main body, which separate the flow channels from one another such that at least two adjacent flow channels are connected together fluidically within the main body in a common end region of the at least two adjacent flow channels; and
channel closures in the common end region for fluid-tight closure of the common end region while maintaining the fluidic connection between the at least two adjacent flow channels in the common end region.

17. The catalyst flow element according to claim 16, wherein at least one of the slots or the channel closures are arranged on the main body in a regular pattern.

18. The catalyst flow element according to claim 16, wherein at least one of the slots or the channel closures are arranged on the main body in such a way that horizontally adjacent flow channels and vertically adjacent flow channels are flowed through in mutually opposed through-flow directions when the catalyst flow element is in operation.

19. The catalyst flow element according to claim 16, wherein the slots are arranged on the main body distributed in such a way that on one side of the main body in each case two flow channels are connected together fluidically by means of one slot.

20. The catalyst flow element according to claim 16, wherein the slots are arranged on the main body distributed in such a way that on one side of the main body in each case one pair of flow channels connected together fluidically by means of one slot is surrounded by four flow channels which directly adjoin the pair of flow channels and are not connected fluidically with further flow channels on this side of the main body.

21. The catalyst flow element according to claim 16, wherein the main body is provided on both sides with slots and channel closures.

22. The catalyst flow element according to claim 16, wherein in each case three flow channels are connected fluidically together by means of in each case two slots, which are arranged at mutually opposite end regions of the flow channels.

23. The catalyst flow element according to claim 16, wherein the slots and the channel closures are arranged on the main body in such a way that the flow channels of every third column or every third row of flow channels are provided on both sides with channel closures.

24. The catalyst flow element according to claim 15, wherein the main body comprises a catalytic coating.

25. A purification device for purifying a crude gas stream, comprising at least one catalyst flow element according to claim 15.

26. A thermal engine, comprising a combustion device, a turbine device, a catalyst flow element according to claim 15 and an exhaust gas flow guide, by means of which exhaust gas removed from the combustion device is configured to be firstly passed through the catalyst flow element and then supplied to the turbine device.

27. Use of a catalyst flow element according to claim 15 for thermal conversion of hydrocarbons, in particular of methane.
